(19) United States
(12) Patent Application Publication
(10) Pub. No.: US 2015/0142495 A1
(43) Pub. Date: May 21, 2015

(54) INTEGRATED APPOINTMENT SCHEDULER AND MANAGEMENT TOOL

(71) Applicant: Courtplay, LLC, Vienna, VA (US)

(72) Inventor: Farshad Garakani, Vienna, VA (US)

(73) Assignee: COURTPLAY, LLC, Vienna, VA (US)

(21) Appl. No.: 14/085,020

(22) Filed: Nov. 20, 2013

(51) Int. Cl. G06Q 10/10

(52) U.S. Cl. CPC G06Q 10/1095
USPC 705/7.19

(57) ABSTRACT

A system and method for automatic integrated appointment scheduling and management where in response to an input a first profile and a second profile are associated and an association heuristic automatically retrieves a plurality of availability instances of the profile. The plurality of availability instances are then presented through an interface for selection.

### BACKGROUND

Communication technologies enabling customers and businesses to connect have evolved from personal encounters. For instance, a potential customer wishing to purchase goods or services in most cases may have in the past been aware of a particular business based on word of mouth, advertisements, and/or general business notoriety. In turn, the potential customer may have called or visited the particular business to discuss transacting for the goods or services with employees of that particular business. However, due to the evolved communication technologies, such as internet websites, social networks, and mobile applications, a business may create an online storefront or presence that enables the same potential customer to be aware of and transact with that business, without ever speaking to or physically meeting employees.

Yet, the online presence of any business must be actively sought and located by the potential customers, i.e., the discovery burden is on the potential customer to find the business. Further, because creating the online presence is relatively simple and cost effective, the internet, social networks, and mobile market have been flooded with options for goods and services. Thus, when using the evolved communication technologies, potential customers have no direct and easy approach, outside of general search systems, to sift through the multitude of both relevant and unrelated online storefronts, while the mere creation of an online presence by a business is insufficient to communicate with the potential customers.

### BRIEF DESCRIPTION OF THE DRAWINGS

FIG. 1 illustrates an exemplary system in which an integrated appointment scheduler and management application operates;

FIG. 2 illustrates an exemplary schematic of an integrated appointment scheduler and management application;

FIG. 3 illustrates an exemplary process flow performed by an integrated appointment scheduler and management application;

FIGS. 4-6 illustrate exemplary interfaces generated by an integrated appointment scheduler and management application;

FIG. 7 illustrates an exemplary process flow performed by an integrated appointment scheduler and management application; and

FIGS. 8-11 illustrate exemplary interfaces generated by an integrated appointment scheduler and management application.

### DETAILED DESCRIPTION

An integrated appointment scheduler and management application (IASMA) has been developed, which operates as a platform to facilitate communications between potential customers and businesses. Facilitation by the IASMA results in a consistent communication mechanism for potential customers and businesses that performs operations beside or in place of the otherwise insufficient communication technologies described above.

For instance, a computing device, which connects to a network within an exemplary communication system, includes on a memory the IASMA. When external users (e.g., potential customers and businesses) connect through the network to the IASMA, the IASMA may provide each external user with an appointment scheduler service and management system solution.

The appointment scheduler service streamlines calendar management and scheduling processes between potential customers and businesses by generating profiles and syncing calendar availability or information between the profiles via association heuristics. A profile is a digital representation of an identity of a potential customer or business. Further, characteristics may be utilized to form the digital representation. Examples of the characteristics may include profile type, contact information, calendar information, location information, personalized information, security information, billing information, and the like. The appointment scheduler service may further generate multiple profile types, each type including a character set variation (e.g., an assortment or collection of characteristics particular to a profile type).

The management system solution enables potential customers and business via profiles to access instant electronic services including front desk management, back office management, scheduling and activity management, and billing and payment processing. Front desk management may be an instant electronic service for managing communications between potential customers and businesses (e.g., between profiles), such as receiving and/or replying to customer messages, inquiries, orders, and the like. Back office management may be an instant electronic service for managing tasks dedicated to running a business, such as administration operations. Scheduling and activity management may be an instant electronic service supported by the generating and syncing operations of the appointment scheduler service. Billing and payment processing may be an instant electronic service for managing the financial aspects of transacting for goods and services.

In addition, operations of the IASMA via the appointment scheduler service and management system solution may provide specialized marketing and customer relationship management tools along with automatic financial and demographic data mining to the potential customers and businesses.

One example of the IASMA in operation may include facilitating communications between potential customers, such as tennis players, and businesses, such as tennis coaches and tennis facilities (e.g., facilitating communications between participants in the tennis industry). That is, tennis coaches who have created and loaded a profile may actively seek players via the IASMA who have indicated through their respective profiles a desire for tennis lesson. Similarly, tennis players may in turn actively seek tennis coaches via the IASMA who have availability to conduct tennis lessons posted to their respective profiles. Further, tennis facilities may also interact with both tennis coaches and players through the IASMA to provide a meeting location for the above tennis lessons.

The IASMA may be accessed by a user who is a beginner level tennis player and receive characteristics (e.g., including profile type, name, contact information, calendar information, and location information), which are utilized to construct a player profile by the IASMA. Next, the IASMA may receive an input (e.g., a synchronization or ‘sync’ command) indicating a selection by the user to schedule a tennis lesson. In response to the selection, the IASMA may automatically compile a set of suggested coaches and facilities based on respective coach and facility profiles that are relative to, for example, the location information (e.g., home address) and the personalized information (e.g., skill level) listed within the player profile.

The IASMA may then present to the user the set of the suggested coaches and facilities, await an input indicating a selection of one of the suggested coaches and/or facilities, and respond to the input by automatically accessing calendar information within the selected one of the profiles to suggest lesson dates and locations for the user. Upon further input, the IASMA may schedule the lesson for, facilitate payment between, and deliver notifications to the now connected player, coach, and/or facility via the respective profiles. In addition, the IASMA may utilize the new connection to automatically deliver advertisements for businesses relative to the home address of the user.

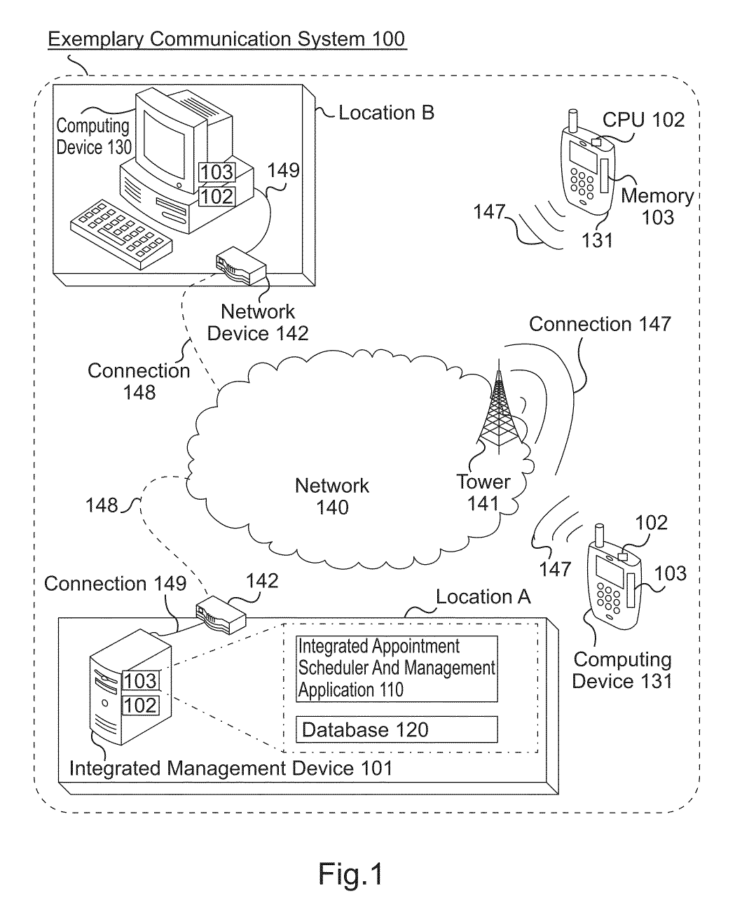

FIG. 1 illustrates an exemplary communication system 100 having an integrated management device 101 that in response to communications received from one or more computing devices 130, 131 utilizes an integrated appointment scheduler and management application (IASMA) 110 to facilitate communications between profiles respective to users of the computing devices 130, 131. The exemplary communication system 100 and items therein, such as the integrated management device 101 and the computing devices 130, 131, may take many different forms and include multiple and/or alternate components and facilities, e.g., as illustrated in the figures further described below. While exemplary systems, devices, modules, and sub-modules are shown in the figures, the exemplary components illustrated in the figures are not intended to be limiting. Indeed, additional or alternative components and/or implementations may be used.

As illustrated in FIG. 1, the exemplary communication system 100 includes the integrated management device 101 and the computing devices 130, 131. Further, the integrated management device 101 may be at a Location A and connected to computing device 130 (at a Location B) and to computing devices 131 (within the system 100) through a network 140 (e.g., infrastructure technologies as described below). Locations A and B may be logical locations respective to the network 140 while at the same time being the same, similar, or different geographic locations. The integrated management device 101 and the computing devices 130, 131 may be any computing system and/or device that includes a processor and a memory (e.g., 102 and 103, respectively).

Computing systems and/or devices generally include computer-executable instructions (e.g., an operating system, IASMA 110, etc.), where the instructions may be executable by one or more computing devices such as those listed below. Computer-executable instructions may be compiled or interpreted from computer programs created using a variety of programming languages and/or technologies, including, without limitation, and either alone or in combination, Java™, C, C++, Visual Basic, Java Script, Perl, etc.

In general, a processor or a microprocessor (e.g., central processing unit (CPU) 102) receives instructions from a memory (e.g., memory 103) and executes these instructions, thereby performing one or more processes, including one or more of the processes described herein. Such instructions and other data may be stored and transmitted using a variety of computer-readable mediums (e.g., memory 103). Further, computing systems and/or devices may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance.

Examples of the computing devices include, without limitation, cell phones, smart-phones, super-phones, tablet computers, next generation portable devices, mobile printers, handheld computer, secure voice communication equipment, or some other computing system and/or device. Alternatively, computing devices may also be a computer workstation, a server, a desktop, notebook, or laptop. Further, computing systems and/or devices may generally include a display or electronic display to present interfaces as described below.

The CPU 102 may include processes comprised from any hardware, software, or combination of hardware or software that carries out instructions of computer programs by performing logical and arithmetical calculations, such as adding or subtracting two or more numbers, comparing numbers, or jumping to a different part of the instructions. For example, the CPU 102 may be any one of, but not limited to single, dual, triple, or quad core processors (on one single chip), graphics processing units, visual processing units, and virtual processors.

The memory 103 may be, in general, any computer-readable medium (also referred to as a processor-readable medium) that may include any non-transitory (e.g., tangible) medium that participates in providing data (e.g., instructions) that may be read by a computer (e.g., by a CPU 102 of the device 101). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire, fiber optics, and the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Thus, in the exemplary illustration of FIG. 1, the memory 103 of the integrated management device 101 may store the IASMA 110 as executable instructions within the operating system for the integrated management device 101, the instruction being executable by the CPU 102 to perform one or more of the processes described herein.

The integrated management device 101 may further include a database, a data repository or other data store (e.g., database 120) that comprises any type of data source and/or file system that operates to support the IASMA 110. For instance, data sources may include profiles, along with licenses (e.g., license permitting control and access by/to the integrated management device 101 of/by third party platforms) relating to the profiles and/or IASMA 110 operability.

In general, databases, data repositories or other data stores (e.g., database 120) described herein may include various kinds of mechanisms for storing, providing, accessing, and retrieving various kinds of data, including a hierarchical database, a set of files in a file system, an application database in a proprietary format, a relational database management system (RDBMS), etc. Each such data store may generally be included within or external to a computing system and/or device employing a computer operating system such as one of those mentioned above, and/or accessed via a network or connection in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

Further, in some examples, the elements of the devices 101, 130, 131 may be implemented as computer-readable instructions (e.g., software) on one or more computing devices (e.g., servers, personal computers, etc.), stored on computer readable media associated therewith (e.g., disks, memories, etc.). A computer program product may also comprise such instructions stored on computer readable media for carrying out the operations described herein.

The network 140 may provide the infrastructure through which the devices 101, 130, 131 communicate. In general, a network (e.g., network 140) may be a collection of computers and other hardware to provide infrastructure to establish virtual connections and carry communications. For instance, a network may be an infrastructure that generally includes edge, distribution, and core computing devices (e.g., tower 141 or network devices 142) and provides a path (e.g., connections 147, 148, 149) for the exchange of information between different devices and systems (e.g., between the devices 101, 130, 131). Further, a network may be any conventional networking technology, and may, in general, be any packet network (e.g., any of a cellular network, global area network, wireless local area networks, wide area networks, local area networks, or combinations thereof, but may not be limited thereto) that provides the protocol infrastructure to carry communications. The network 140 is representative, and thus while a single cloud illustrates the network 140, this illustration may represent a single network, a combination of different networks components and technologies, and/or a plurality of networks, as described above.

The network devices 142 may be a computing device that is a gateway between connections 148, 149 to complete a portion of a path between the devices 101, 130 (of Locations A, B respectively) to other devices connected to the network 140.

The tower 142 may be a tall structure designed to support antennas or aerials for telecommunications amongst the system 100. The tower 142 may enable the connections 147 that carry signals to or from the network 140 (e.g., the connection 147 from the network 140 via the tower 141 to the computing devices 131).

The connections 147, 148, 149 may be wireless or wired connections between two endpoints (e.g., devices, sub-systems, or systems) that carry electrical signals that facilitate virtual connections. Examples of the connections 147, 148, 149 may be any transmission media including radio waves, coaxial cables, copper wire, fiber optics, and the like. Virtual connections are comprised of the protocol infrastructure that enables communication to and from the devices 101, 130, 131.

Thus, for example, the connections 147 may be the wireless connections between the computing devices 131 and the tower 141, and the tower 141 may enable a computing device 131 to connect to and access the systems, devices, and data associate with, contained within and connected to the network 140, providing the computing device 131 is located within a transmission range of the tower 141. Further, the connections 148 may be the wired connections between the network 140 and the network devices 142, while the connections 149 may be the wired connection between the network devices 142 and the devices 101, 130. Further, the combination of the connections 147, 148, 149 and the network 140 may provide the virtual connections between the devices 101, 130, 131 to enable communication.

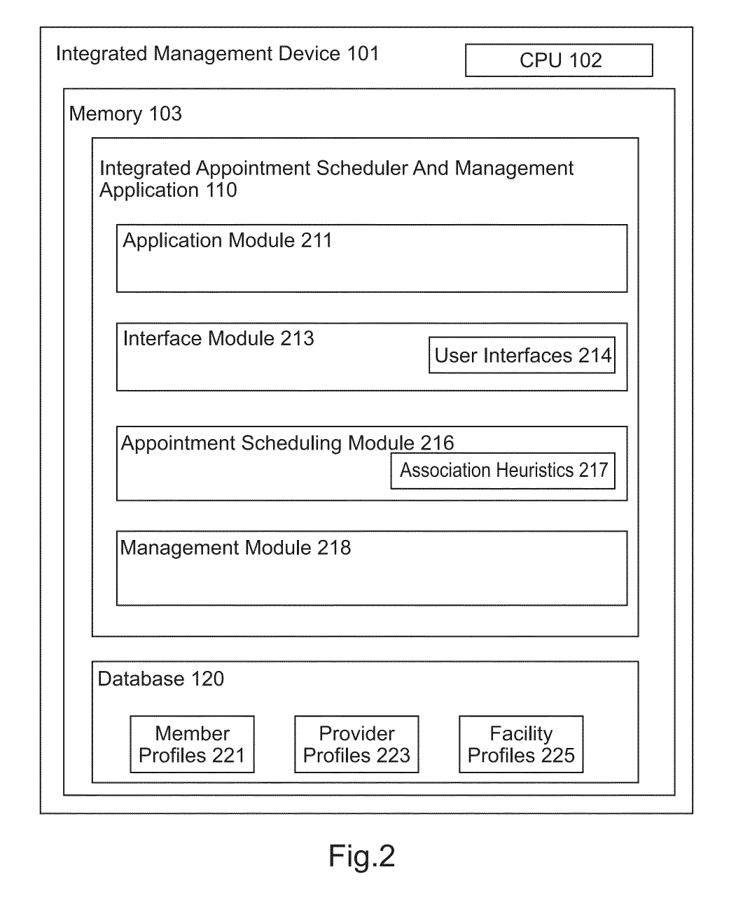

FIG. 2 illustrates an example of the integrated management device 101. For instance, the integrated management device 101 may include on a memory 103 the IASMA 110 and the database 120, each of which including components thereof (note that items that have been previously discussed may be utilized to denote the same or similar items in subsequent figures). The IASMA 110, the database 120, and their respective components are preferably provided as software that when executed by the CPU 102 provides the operations described herein. Alternatively, the IASMA 110, the database 120, and their respective components may be provided as hardware or firmware, or combinations of software, hardware and/or firmware. Additionally, although one example of the modularization of the IASMA 110 is illustrated and described, it should be understood that the operations thereof may be provided by fewer, greater, or differently named modules.

As illustrated in FIG. 2, the IASMA 110 may include an application module 211, an interface module 213 that generates user interfaces 214, an appointment scheduling module 216 that executes an association heuristic 217, and a management module 218. Further, the database 120 may store and manage profiles, such as member profiles 221, provider profiles 223, and facility profiles 225. In general, the integrated management device 101 utilizes the IASMA 110, the database 120, and their respective components to provide the appointment scheduler service and the management system solution. The integrated management device 101 further utilizes the IASMA 110, the database 120, and their respective components to generate, manage, and store the profiles 221, 223, 225.

For example and in view of the tennis industry example above, the IASMA 110 through its modules may be accessed by a tennis player, coach, and/or facility; receive characteristics based on inputs; and generate player, coach, and/or facility profiles (e.g., respectively profiles 221, 223, 225), along with enabling the customization of those profiles such that any player, coach, and/or facility may take an active or passive role in the communications of the tennis industry. The IASMA 110 may also receive inputs (e.g., operation commands, sync commands) that initiate or trigger automatic operations by the IASMA 110, such as the automatic synchronizing of the player, coach, and/or facility profiles respective to a pre-loaded profile or a set of criteria; the presentation of player, coach, and/or facility profile suggestions based on the synchronization; the automatic accessing of calendar information within player, coach, and/or facility profiles and within systems external to the system 100. The IASMA 110 through its modules may further schedule lessons for, facilitate payments between, and deliver notifications to a player, coach, and/or facility via a respective profile. The IASMA 110 through its modules may further provide specialized marketing and customer relationship management tools along with automatic financial and demographic data mining, where financial and demographic data mining may include, for example, compiling data regarding age, gender, time of year, skill level, region, peak season per region, gear purchase trends, etc.

The application module 211 may include program code configured to facilitate communication between the modules of the IASMA 110 and hardware/software components external to the IASMA 110. For instance, the application module 211 may include program code configured to communicate directly with other applications, modules, models, devices, and other sources through both physical and virtual interfaces. That is, the application module 211 may include program code and specifications for routines, data structures, object classes, and variables that package and present data received from user interfaces 214 generated by the interface module 213 for transfer over a network or through a connection (e/g/. network 140 and connections 148, 149). In one illustrative approach, the IASMA 110 may be accessed via the application module 211 by the computing devices 130, 131, and in reply may provide user interfaces 214 (or data to support the generation of user interface by the devices 130, 131) as generated by the interface module 213 via the application module 211.

The interface module 213 may include program code for generating and managing user interfaces 214 that control and manipulate the IASMA 110 based on a received input. For instance, the interface module 213 may include program code for generating, presenting, and providing one or more user interfaces 214 (e.g., in a menu, icon, tabular, map, or grid format) in connection with other modules for providing information (e.g., data, notifications, counters, instructions, etc.) and receiving inputs (e.g., characteristics, user selections, operation commands, sync commands, etc.). The user interfaces 214 may also include notifications, icons banners, badges, alerts, sounds, text, or any combinations thereof. A banner may be a media or drop-down menu that extends from a top portion of an interface, a sub-interface, and/or display of a computing device and that may include text, badges, and animated symbols. An icon and/or a badge may be a number or symbol that signals a link, an event, or a number of events. An alert may be a pop-up window that may be centered on the display and that may include text, badges, and animated symbols.

The interface module 213 may also present user interfaces 214, such as IASMA interfaces described below, to display information relative to the profiles 221, 223, 225, along with the selecting and configuring of the profiles 221, 223, 225. The user interfaces 214 described herein may also be provided as software that when executed by the CPU 106 provides the operations described herein. The user interfaces 214 may also be provided as hardware or firmware, or combinations of software, hardware, and/or firmware.

The appointment scheduling module 216 may include program code for providing the appointment scheduler service. For instance, the appointment scheduling module may include program code for generating the profiles 221, 223, 225 (e.g., multiple profile types, each type including a character set variation).

For instance, the appointment scheduling module 216 may generate a character set variation for a member type profile (e.g., member profile 221) that includes the particular characteristics of contact information, such as names, phone numbers, emails, and addresses; personalized information, such as preferred locations, distance ranges, experiences, specialties, gender, preferred providers, preferred provider characteristics, and public/private profile settings; and billing information, such as banking information, credit information, etc. The appointment scheduling module 216 may generate a character set variation for a provider type profile (e.g., provider profile 223) that includes the particular characteristics of contact information, such as business names, employees names, phone numbers, emails, and addresses; personalized information, such as business locations, preferred locations, experiences, specialties, gender, preferred customer characteristics, response time, ratings, recommendations, and public/private profile settings; and billing information, such rates, banking information, credit information, etc. The appointment scheduling module 216 may generate a character set variation for a facility type profile (e.g., facility profile 223) that includes the particular characteristics of contact information, such as names, phone numbers, emails, and addresses; personalized information, such as preferred locations, experiences, specialty, amenities, number of locations, preferred provider/customer characteristics, and public/private profile settings; and billing information, such as hourly rate, membership rates, rating, banking information, and credit information, etc.

The appointment scheduling module 216 may also include program code for executing association heuristics 217 that may streamline calendar management and scheduling processes by syncing calendar availability or information between the profiles 221, 223, 225. For instance, the association heuristics 217 may retrieve a plurality of availability instances for profiles 221, 223, 225 by retrieving open time instances within calendar information of the profiles. This may include automatically synchronizing the open time instances between the profiles to generate a synchronized instance set and/or applying a time range (e.g., a predetermined date and time filter) to the synchronized instance set and. Further, the association heuristic may automatically associate a multiplicity of profiles from different profile types (e.g., three different profile types), and retrieve a plurality of mutual availability instances for the multiplicity of profiles. Note that the presentation of the plurality of availability instances may be represented on a timeline. Further, the plurality of availability instances may also be presented and/or represented as profile instances on a time range or table, icons in a grid from or a calendar, badges or pins on a map, and the like.

In view of the tennis industry example above, the appointment scheduling module 216 may include a coaching appointment scheduler service that streamlines skill management and scheduling processes between tennis players, coaches, and/or facilities (e.g., tennis courts) by generating player, coach, and/or facility profiles and syncing availability associated with those profiles. In one operation, the coaching appointment scheduler service may utilize player, coach, and/or facility profiles for automatic player/coach/facility suggestions based on, for example, player's skill level, a coach's rating, and facility's location. That is, a beginner level player may be matched with a coach having a high rating for teaching beginners while a facility that is within a predetermined distance from the address information of both the player and coach is suggested as a meeting place. Further, the coaching appointment scheduler service may access/retrieve calendar information (e.g., within the profiles or from a source external to the integrated management device 101) relative to the suggested profiles in support of automatically compiling accurate meeting times (e.g., the plurality of availability instances).

The management module 218 may include program code for providing the management system solution. For instance, the management module 218 may include program code for providing instant electronic services including front desk management, back office management, scheduling and activity management, and billing and payment processing.

In view of the tennis industry example above, the management module 218 may be a court-sheet management system solution that enables tennis facilities to provide the above identified electronic services. In one operational example of billing and payment processing, the court-sheet management system solution may enable different fee structures based on profile types or facility use (e.g., a beginner lesson for a half hour time block may cost a first fee, while court reservation time for a tennis match between experts may cost another fee). In another operational example of billing and payment processing, different profiles types may purchase or earn points/credits for booking tennis lessons and/or to spend on merchandise listed by the IASMA 110 (e.g., booking court reservations for recommending a new member or for purchasing above an amount, purchasing tennis gear for submitting feedback, utilizing gift cards and/or coupons, etc.).

One operational example of front and back office management may include virtual receptionist services where facility notifications, employee scheduling, membership management, and point-of-sale services for pro-shops are managed by the court-sheet management system solution. Similarly, the court-sheet management system solution may enable marketing and customer relationship management tools for player, coach, and/or facility profiles, such as creating a feedback system for rating players, coaches, and facilities.

The database 120, as described above, may include various kinds of mechanisms for storing, providing, accessing, and retrieving various kinds of data, such as profiles 221, 223, 225. Member profiles 221, provider profiles 223, and facility profiles 225 are different profile types that digitally represent different customers and/or businesses.

For instance, in view of the above example of the IASMA 110 facilitating communications between tennis players, tennis coaches, and tennis facilities, the database 120 may store and provide member profiles 221 that represent tennis players and may include the characteristics of contact information (e.g., names, addresses, emails, phone numbers, etc.); calendar information (e.g., appointments, unavailable time, imported calendar data, etc.); location information (e.g., home address, home court addresses, distance preferences, etc.); personalized information (e.g., skill level, court preferences, preferred locations, distance ranges, coach preferences, preferred coach characteristics, experiences, specialties, gender, times preferences, hand orientation (e.g., plays right/left), and public/private profile settings etc.); security information (e.g., passwords, authentication information, etc.); billing information (e.g., banking and/or credit card information, etc.); and the like for that tennis player.

Further, the database 120 may store and provide provider profiles 223 that represent tennis coaches and may include the characteristics of contact information (e.g., business names, employees names, addresses, emails, phone numbers, etc.); calendar information (e.g., appointments, unavailable time, imported calendar data, tennis lesson lengths, etc.); location information (e.g., business addresses, business locations, home court addresses, distance preferences, etc.); personalized information (e.g., skill level, court preferences, preferred locations, distance ranges, player preferences, preferred player characteristics, experiences, specialties, gender, times preferences, hand orientation (e.g., plays right/left), response time, ratings, recommendations, and public/private profile settings etc.); security information (e.g., passwords, authentication information, etc.); billing information (e.g., rates, banking and/or credit card information, etc.); and the like for that tennis coach.

The database 120 may also store and provide facility profiles 225 that represent tennis facilities and may include the characteristics of contact information (e.g., business names, employees names, phone numbers, emails, addresses); personalized information (e.g., preferred locations, experiences, specialty, amenities, number of locations, preferred coach/player characteristics, public/private profile settings); and billing information (e.g., hourly rate, membership rates, rating, banking information, credit information, etc.). Also, facility profiles 225 may further be divided into, e.g., sub-facility profiles that identify private and public facilities such that the characteristic of, for example, public courts and private clubs may be included in each respective profile sub-type. Note that listed characteristics of the above profiles 221, 223, 225 are exemplary and should not be construed as limiting.

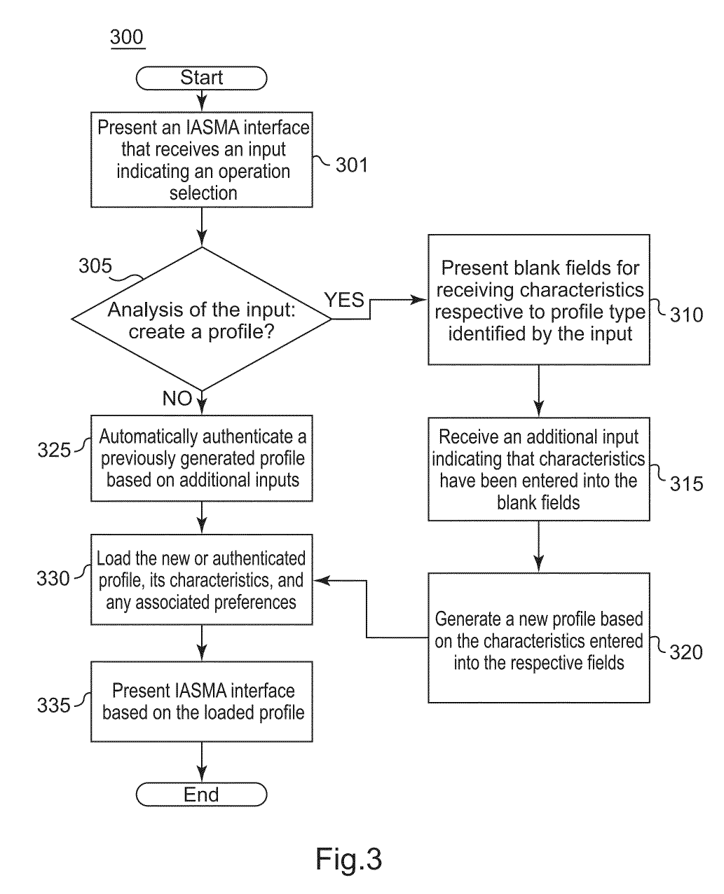

FIG. 3 illustrates an exemplary process flow 300 for generating and presenting profiles 221, 223, 225 by the IASMA 110. In general, the IASMA 110 may present 301 an IASMA interface (e.g., user interface 214) to a user and receive an input indicating a selection by the user to perform an operation, such as to create or authenticate a profile. The IASMA 110 may in turn analyze 305 the input in preparation of loading the newly created or authenticated profile.

When the input indicates a selection by the user to create a profile (‘YES’), the IASMA 110 may automatically present 310 a set of fields to receive 315 characteristics (e.g., including profile type, name, contact information, calendar information, and location information), which are utilized to construct or generate 320 the profile by the IASMA 110. When the input indicates a selection by the user to authenticate a profile (‘NO’), the IASMA 110 may automatically authenticate 325 a previously generated profile based on additional authentication inputs received by the IASMA 110. In both cases, the IASMA 110 may load 330 the created or authenticated profile, its characteristics, and any associated preferences for presentation 335 (e.g., as a currently loaded profile) via another IASMA interface. Next, the process 300 ends.

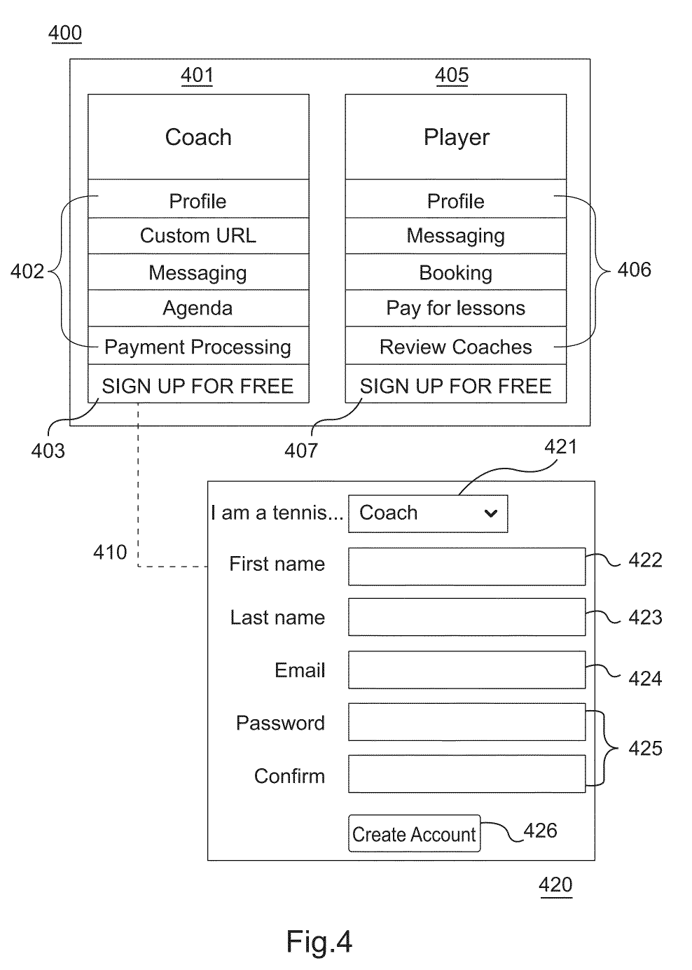

FIGS. 1-3 will now be described in reference to the above tennis industry example, with further references to FIGS. 4-6. FIGS. 4-6 illustrate exemplary interfaces and sub-interfaces (e.g., 400, 401, 405, 420, 500, 620) generated by an IASMA 110.

In the exemplary process flow 300, upon initial access the IASMA 110 presents 301 an IASMA interface 400 in response to an initial access by a user, such as a tennis player or coach. The exemplary interface 400 may include sub-interfaces 401, 405, which may be presented simultaneously (as illustrated) or individually, that relate to creating tennis coach profiles (e.g., provider profiles 223) and tennis player profiles (e.g., member profiles 221), respectively.

In the case of the ‘Coach’ sub-interface 401, the IASMA 110 identifies in a list 402 of characteristics or operations (e.g., header identifying a particular character set variation or operation) that may generally be associated with a tennis coach profile. The list 402 as illustrated may include: ‘Profile,’ which indicates that a tennis coach may be able to configure and maintain a tennis coach profile; ‘Custom URL,’ which indicates that a tennis coach may be able to configure and maintain a dedicated webpage within the exemplary communication system 100 for the tennis coach profile; ‘Messaging,’ which indicates that a tennis coach may be able to configure and maintain communications with other profiles; ‘Agenda’, which indicates that a tennis coach may be able to configure and maintain a schedule; and ‘Payment Processing,’ which indicates that a tennis coach may be able to conduct monetary exchanges. Further, the ‘Coach’ sub-interface 401 may include a ‘SIGN UP FOR FREE’ button 403 that when selected transitions 410 to, for example, an IASMA interface 420 that may permit a user to enter characteristics associated with the items in the list 402.

In the case of ‘Player’ sub-interface 405, the IASMA 110 identifies in a list 406 of characteristics or operations (e.g., a particular character set variation) that may generally be associated with a tennis player profile. The list 402 as illustrated may include: ‘Profile,’ which indicates that a tennis player may be able to configure and maintain a tennis player profile; ‘Messaging,’ which indicates that a tennis player may be able to configure and maintain communications with other profiles; ‘Booking,’ which may be an lesson reservation operation with other profiles; ‘Pay for lessons,’ which may be a monetary exchange operation for the tennis player profile; and ‘Review Coaches,’ which may be another communication feature to browse and comment on tennis coach profiles. Further, the sub-interface 405 may include a ‘SIGN UP FOR FREE’ button 407 that when selected transitions to an IASMA interface that may permit a user to enter characteristics associated with the items in the list 406.

Further, when the IASMA 110 presents 301 the interface 400 to the user and the IASMA 110 may also receive an input indicating the selection of the ‘SIGN UP FOR FREE’ button 403. Based on this input, the IASMA 110 identifies 605 that a new coach profile should be created (‘YES’) and therefore transitions 410 to data entry sub-interface 420, which presents 310 fields for receiving characteristics of a coach profile type. When the data entry sub-interface 420 is presented, a profile type field 421 (e.g., ‘I am a tennis . . . ’) may default to present the profile type ‘Coach’ based on the selection of ‘SIGN UP FOR FREE’ button 403 of the ‘Coach’ sub-interface 401. Similarly, if ‘SIGN UP FOR FREE’ button 407 is selected, then the profile type field 421 may default to ‘Player.’ Further, the profile type field 421 may be configured to present any profile designation type, e.g., member, provider, facility and/or equivalents/variations thereof. The data entry sub-interface 420 may then permit the receipt of characteristics by the IASMA 110 via a ‘First name’ field 422, a ‘Last name’ field 423, an ‘Email’ field 424, and ‘Password’ and ‘Confirmation’ fields 425. Note that fields of data entry sub-interface 421 are exemplary and should not be construed as limiting.

Next, when the IASMA 110 receives an input indicating a selection of a ‘Create Account’ button 426, the IASMA 110 may generate 320 a new profile using the characteristics entered into the respective fields 422-425 and according to the profile type identified by the profile type field 421. In the case of data entry sub-interface 420, since the profile type field 421 displays ‘Coach,’ a coach profile type may be generated by the IASMA 110.

As indicated above, the IASMA 110 may also authenticate 325 a previously generated profile. That is, the IASMA 110 may receive inputs indicating authentication information for accessing a player, coach, and/or facility profile, such that when the authentication is complete the IASMA 110 loads 330 preferences and characteristics associated with the authenticated profile.

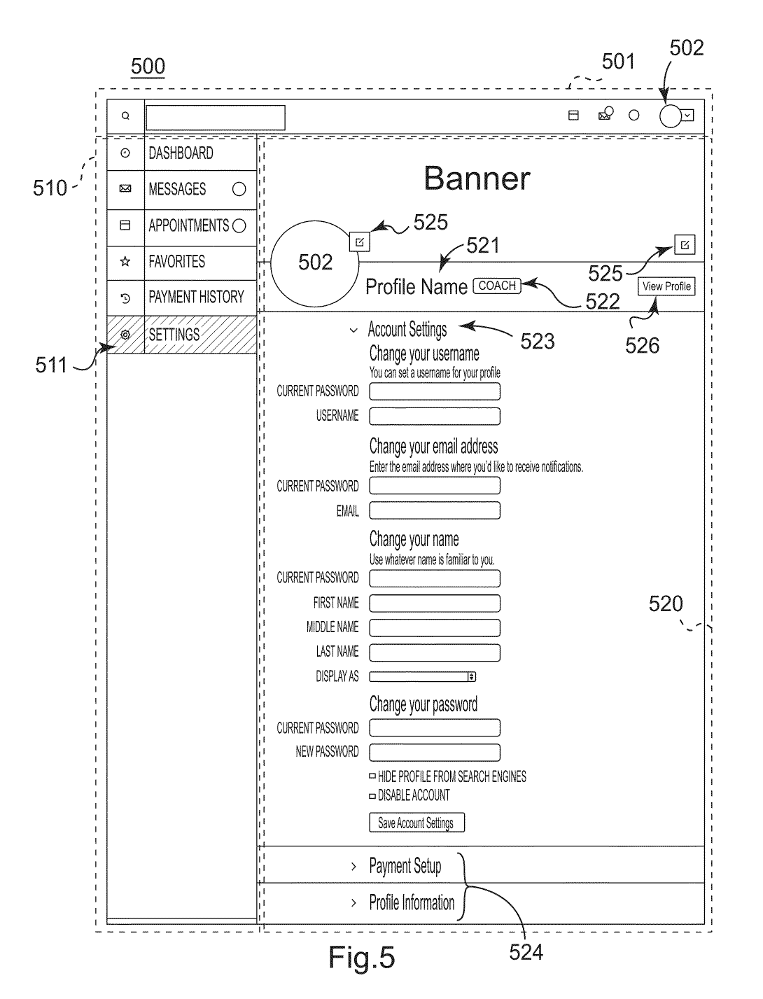

Once the authenticated or newly created profile is loaded (e.g., the currently loaded profile), the IASMA present another IASMA interface (e.g., interface 500). The exemplary interface 500 of FIG. 5 may include a sub-interface or header-menu 501 that maintains icons, search fields, and badges associated with the currently loaded profile. The header-menu 501 may include, for instance, a picture within window 502 as designated by the currently loaded profile. Further, the icons within header 501 may be selectable, such that other portions of the interface 500 may be altered (e.g., sub-menu 510 and/or display window 520) in response to their selection. The exemplary interface 500 may further include a sub-interface or sub-menu 510, which via selectable script or tiles lists features or operations available to a user. Further, based on which tile is selected from a list, a sub-interface or display window 520 is altered to present information associated with the selected tile.

In this example, the settings feature is selected via a ‘SETTINGS’ tile 511 from the sub-menu 510 as indicated by shading. In turn, the display window 520 presents information in accordance with the selected ‘SETTINGS’ tile 511. Similarly, if one of the ‘DASHBOARD,’ ‘MESSAGES,’ ‘APPOINTMENTS,’ ‘FAVORITES,’ or ‘PAYMENT HISTORY’ tiles were selected from the sub-menu 510, then the display window 520 may present information according to or associated with that tile.

When the ‘SETTINGS’ tile 511 is selected, the display window 520 presets an attractive and user friendly sub-interface for updating and/or changing characteristics of the currently loaded profile. The ‘Profile Name’ 521 and profile type 522 may display the characteristics entered in the ‘First name’ field 422, the ‘Last name’ field 423, and the profile type field 421 (e.g., Coach, Player, or Facility) and/or the characteristics associated with similar fields in a previously generated profile. In this illustrated case, because the profile type field 421 displayed ‘Coach,’ the character set variation presented by the display window 520 may be associated with the coach profile type (e.g., as indicated by the profile type 522). Further, the display window 520 may also include field headers 523, 524, which permit the expanding and collapsing of data entry fields according to a particular header within the display window 520.

The exemplary interface 500 may include icons 525, which through their selection initiate an edit command that may permit updating and/or changing of a multimedia within windows 502 or a banner of the display window 520. Also, the display window 520 of the exemplary interface 500 may be equipped with a ‘View Profile’ button 526 that permits the presentation of the currently loaded profile as a currently viewed profile (e.g., such as when the ‘DASHBOARD’ tile is selected from the sub-menu 510 or when another user views the currently loaded profile).

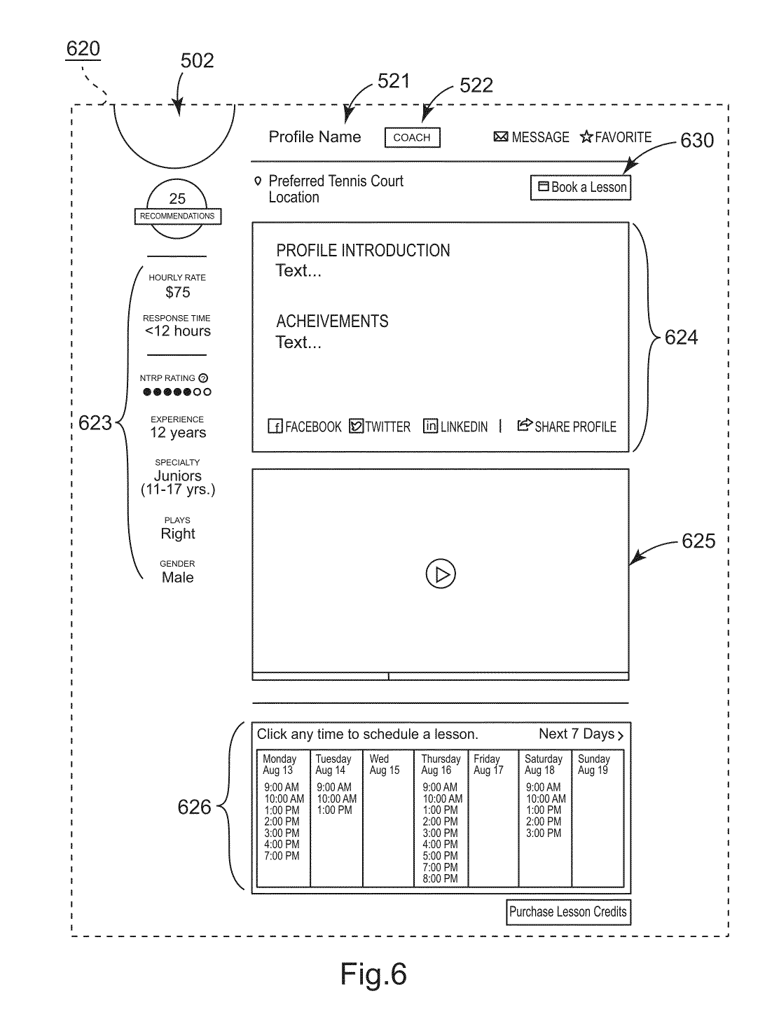

For instance, when the ‘View Profile’ button 526 is selected, the IASMA 110 may present the currently viewed profile via an exemplary sub-interface or display window 620 (e.g., within exemplary interface 500 in place of the display window 520), as illustrated in FIG. 6. That is, FIG. 6 illustrates a currently viewed profile as viewed by other users. The sub-interface or display window 620 may include the sub-interfaces of a characteristic sub-menu 623, a profile introduction sub-window 624, a profile video sub-window 625, a schedule sub-window 626, and a ‘Book a Lesson’ button 630.

The characteristic sub-menu 623 may be a portion of the display window 620 that may list personalized information and billing information, such as hourly rate, response time, rating, experiences, specialty, hand orientation (e.g., ‘PLAYS’), gender, etc.

The profile introduction sub-window 624 may be a portion of the display window 620 that may include a customized description of a person or facility associated with the currently loaded profile. For instance, a tennis coach may include a personal introduction, along with their achievements as a coach, a tennis player may include a set of personal goals for developing their tennis game, and a tennis facility may include a description of the facility along with included and/or paid for amenities.

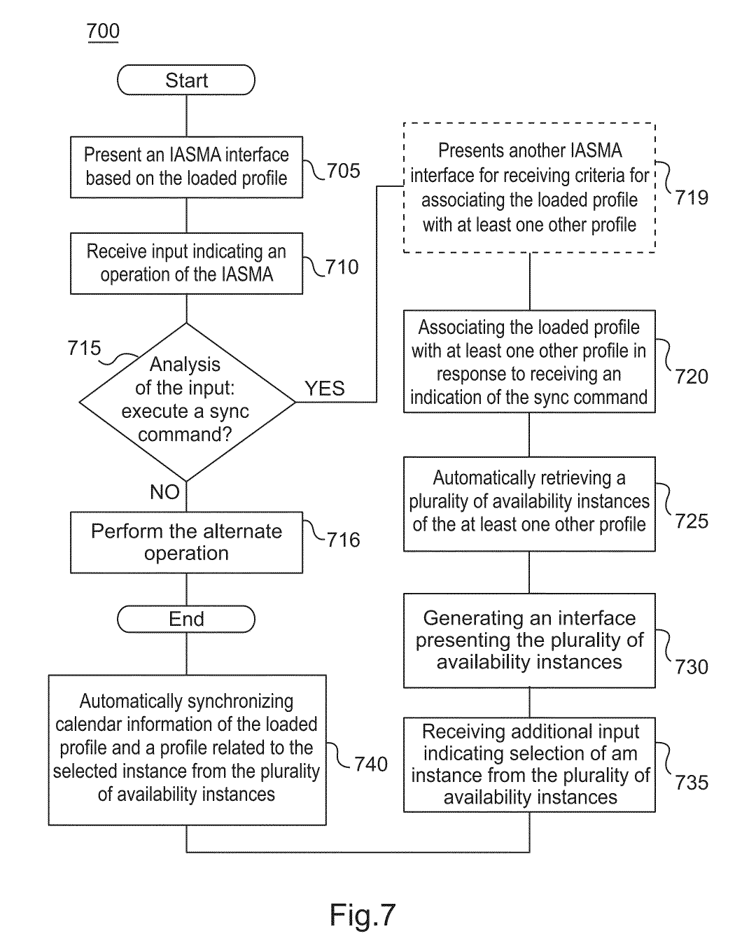

The profile video sub-window 625 may be a portion of the display window 620 that may include a multimedia file (e.g., MPEG-4). The schedule sub-window 626 may be a portion of the display window 620 that may present availability instances of the calendar information associated with the currently loaded profile, where each instance is selectable and in turn initiates or triggers automatic operations by the IASMA 110 when selected. The ‘Book a Lesson’ button 630 may be a portion of the display window 620 that when selected may also initiate or trigger automatic operations by the IASMA 110 (e.g., initiate a portion of the process described in FIG. 7).

FIG. 7 illustrates an exemplary process flow 700 for synchronizing profiles by an IASMA 110. In general, the exemplary process flow begins 700 begins with the presentation of an IASMA interface (e.g., user interface 214) to a user by the IASMA 110 that displays a loaded profile, its characteristics, and any associated preferences (e.g., the currently loaded profile). The IASMA 110 may receive 710 an input indicating an operation of the IASMA 110, and in turn analyze 715 the input in preparation of performing the indicated operation.

When the input indicates a selection by the user to execute a synchronization or ‘sync’ command (‘YES’), the IASMA 110 via the association heuristics 217 of the appointment scheduling module 216 may automatically associate 720 the currently loaded profile with at least one other profile, retrieve 725 a plurality of availability instances of the at least one other profile, generate 730 an interface presenting the plurality of availability instances, receive 735 additional input indicating selection of an instance from the plurality of availability instances, and synchronize 740 calendar information of the currently loaded profile and a profile related to the selected instance from the plurality of availability instances. When the input indicates a selection by the user to execute an alternate operation (‘NO’), the IASMA 110 may perform 716 the operation designated by the input. Next, the process 700 ends.

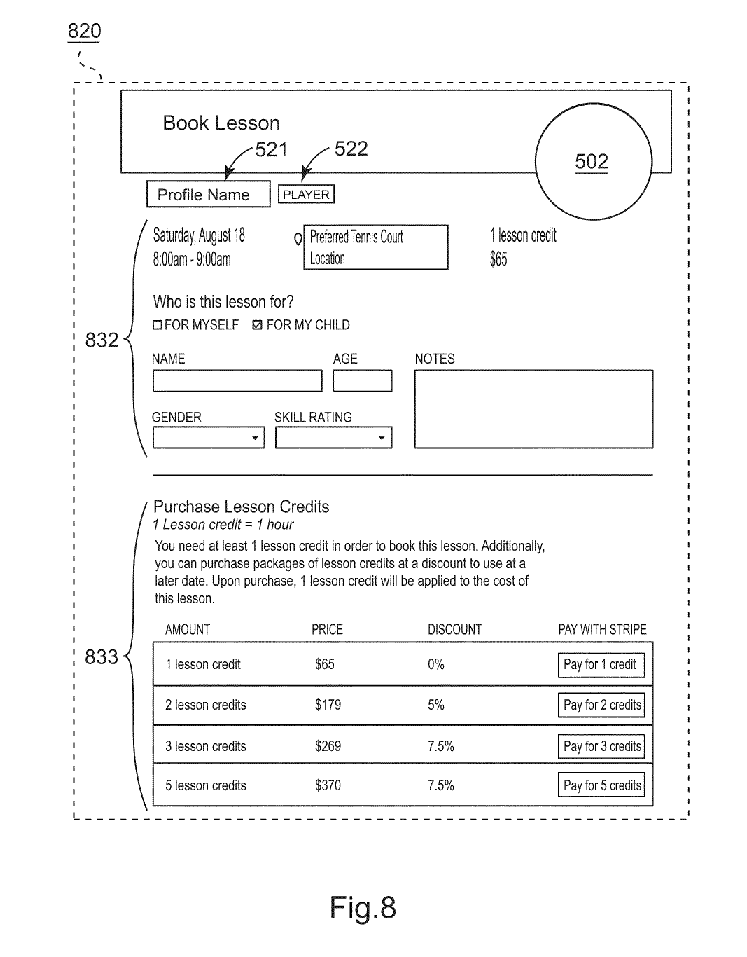

FIGS. 1-7 will now be described in reference to the above tennis industry example with further references to FIGS. 8-11. FIGS. 8-11 illustrate exemplary interfaces and sub-interfaces (e.g., 820, 900, 1020, and 1100) generated by an IASMA 110. Note that in the case of FIG. 7, a currently loaded profile may be that of a tennis player profile as indicated by the profile type 522 of FIG. 8 (further described below), rather than the tennis coach profile as indicated by the profile type 522 of FIG. 5.

The exemplary process flow 700 begins with the presentation 705 of an IASMA interface (e.g., interface 500 including the display window 620 based on step 335 of FIG. 3) by the IASMA 110 that presents the currently loaded profile, its characteristics, and any associated preferences (i.e., the character set variation of the tennis player profile discussed above). That is, an input such as the selection of the ‘View Profile’ button 526 may cause the IASMA 110 to present 705 a display window 620 within the interface 500. In turn, the IASMA 110 may receive 710 an input indicating an operation of the IASMA 110.

Next, the IASMA 110 analyzes 715 the input indicating an operation. When the input indicates (‘NO’) a selection by the user to execute an alternate operation (e.g., an operation other than a sync command), the IASMA 110 may perform 716 the operation designated by the input. Alternate operations may include, for example, the playing of a multimedia file associated with the profile video sub-window 625 by the IASMA 110.

When the input indicates (‘YES’) a selection by the user to execute the sync command, the IASMA 110 via the association heuristics 217 may proceed to automatically synchronize profiles. Note that the sync command may be indicated by, for example, a selection of the ‘Book a Lesson’ button 630 or a selection of an availability instance within the schedule sub-window 626.

Before automatically synchronizing profiles, the IASMA 110 may optionally (as indicated by the dotted box) present 719 another IASMA interface (e.g., exemplary sub-interface or display window 820 of FIG. 8 within the interface 500 in place of the display window 520) for receiving criteria for associating the currently loaded profile with at least one other profile. FIG. 8 illustrates the exemplary display window 820 that presents the currently loaded profile of a tennis player profile as indicated by the profile type 522 of FIG. 8, rather than the tennis coach profile as indicated by the profile type 522 of FIG. 5. Further, FIG. 8 includes the sub-interfaces of a lesson scheduling sub-window 832 and a lesson credit sub-window 833. The lesson scheduling sub-window 832 includes fields in which a user (e.g., a tennis player) may manipulate criteria for arranging a tennis lesson, such as inputting a predetermined time range, a predetermined location and/or distance, a gender, a skill level/rating, and the like. The lesson credit sub-window 833 includes fields in which the user may further identify how to process payment for the tennis lesson.

Next, the IASMA 110 via the association heuristics 217 of the appointment scheduling module 216 may associate 720 the currently loaded profile (e.g., tennis player profile) with at least one other profile. For instance, in response to the IASMA 110 receiving 710 an input indicating selection of the ‘Book a Lesson’ button 630, the IASMA 110 may automatically compile a set of suggested coaches and facilities for the tennis player based on coach and facility profiles 223, 225 of the database 120 that are relative to, for example, the location information (e.g., home address) and/or the personalized information (e.g., skill level) listed within the tennis player profile.

Thus, in general, the IASMA 110 may associate 720 a loaded profile (e.g., a first profile which may be a player, coach, or facility profile) with another profile (e.g., a second profile which also may be player, coach, or facility profile) in response to a sync command (e.g., first input) received by the IASMA 110 of the integrated management device 101. The second profile may be associated based on at least one characteristic identified by the first profile, while the at least one characteristic may be any of the examples of the characteristics included above (e.g., may include profile type, contact information, calendar information, location information, personalized information, security information, billing information).

Next, the IASMA 110 via the association heuristics 217 of the appointment scheduling module 216 may retrieve 725 a plurality of availability instances of the at least one other profile (second profile). For instance, the association heuristics 217 may retrieve a plurality of availability instances relative to each of the suggested coaches and facilities for the tennis player by retrieving open time instances within calendar information of their respective profiles. Further, the association heuristics 217 may apply, for example, a time range to filter the plurality of availability instances to generate a synchronized instance set.

Next, the IASMA 110 via the association heuristics 217 may generate 730 an interface (e.g., interfaces 900, 1020) presenting the plurality of availability instances.

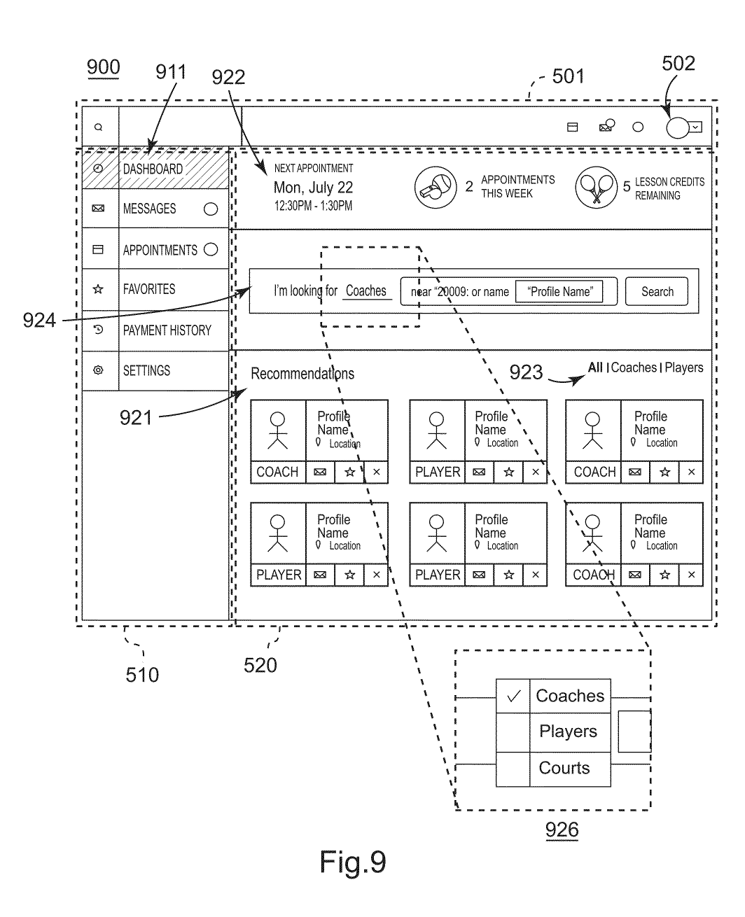

FIG. 9 illustrates an exemplary interface 900 generated by an IASMA 110. In this example, the dashboard feature is selected via a ‘DASHBOARD’ tile 911 from the sub-menu 510 as indicated by shading. In turn, the display window 520 presents information in accordance with the selected ‘DASHBOARD’ tile 911. In the case of generating 730 an IASMA interface presenting the plurality of availability instances, the display window 520 of FIG. 9 may preset a grid of ‘Recommendations’ 921 for ‘Mon, July 22 12:30 PM-1:30 PM’ 922. Note that the grid of ‘Recommendations’ 921 includes ‘All’ 923 profile types 522. Also note that a user may optionally choose to further filter the plurality of availability instances by utilizing a search bar 924 and selecting a particular profile type, as illustrated in a selection sub-interface 926.

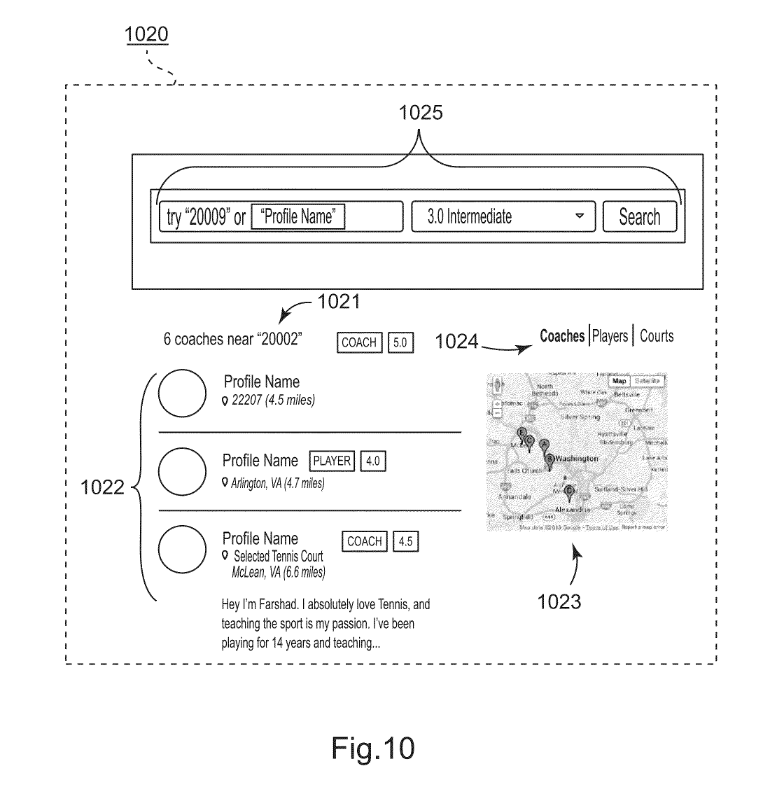

FIG. 10 illustrates an exemplary sub-interface or display window 1020 generated by an IASMA 110, where the display window 1020 of FIG. 10 may be presented within the interface 900 in place of the display window 520. In this example, the display window 1020 includes a title 1021, a coach listing 1022, a map 1023, a filter menu 1024, and a search bar 1025.

Display window 1020 may, for example, be an IASMA interface presenting the plurality of availability instances as generated in step 730. For instance, the title 1021 illustrates that the plurality of availability instances includes ‘6 coaches near “20002”,’ where 20002 may be a predetermined filter location. Note that the display window 1020 illustrates at least two different presentations of the plurality of availability instances with three of the six availability instances being itemized by the coach listing 1022 (which is scrollable), while five of the six availability instances are presented as pins on the map 1023 (which is adjustable). Further, the filter menu 1024 and the search bar 1025 may be optionally utilized to further filter the plurality of availability instances presented by the display window 1020.

Next, the IASMA 110 via the association heuristics 217 of the appointment scheduling module 216 may receive 735 additional input indicating selection of an instance from the plurality of availability instances. For instance, any of the plurality of availability instances may be selected via the exemplary interface 900 or the exemplary display window 1020.

Next, the IASMA 110 via the association heuristics 217 may synchronize 740 calendar information of the currently loaded profile and a profile related to the selected instance from the plurality of availability instances. For instance, calendar information within the tennis player profiles is synchronized with calendar information of a tennis coach profile identified by selection of the profile from the exemplary display window 1020 (e.g., a second profile) to produce an appointment for both the tennis player and coach. In the case where a tennis player initiates the tennis lesson booking, the IASMA 110 may provide an approval mechanism to the tennis coach.

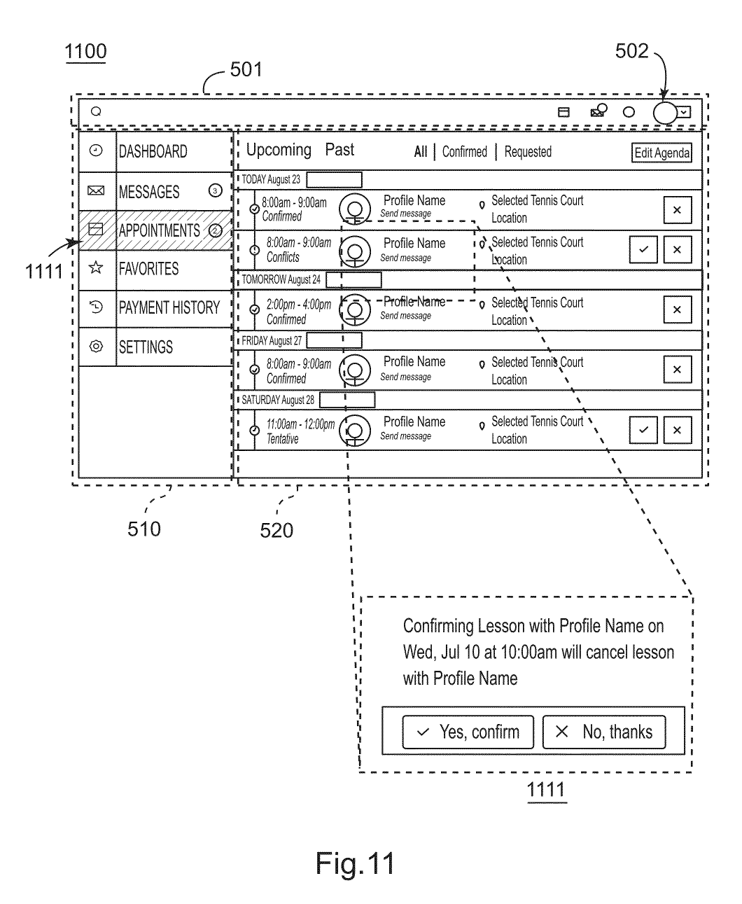

FIG. 11 illustrates an exemplary interface 1100 generated by an IASMA 110 for the tennis coach profile (selected in step 735), which includes an ‘APPOINTMENTS’ tile 1101 and an approval pop-up 1111. Note that in this example, since the appointment feature is selected via the ‘APPOINTMENTS’ tile 1101 from the sub-menu 510 (as indicated by shading), the display window 520 presents information in accordance with the selected ‘APPOINTMENTS’ tile 1101. Further, in this example, the approval mechanism is illustrated by the approval pop-up 1111, which permits the tennis coach to approve by selecting ‘Yes, confirm’ or reject by selecting ‘No, thanks’ the automatic scheduling of a lesson. Thus, tennis players may actively seek tennis coaches who have availability posted to their respective provider profiles and schedule a lesson. Similarly, a tennis coach who has loaded their respective provider profile may actively seek tennis players who have indicated a desire to take tennis lesson by configuring their respective member profile.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description or below Abstract, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A computer-readable medium tangibly embodying an integrated appointment scheduler and management application, the integrated appointment scheduler and management application being executable by a processor of a computing device to provide operations comprising:
associating a first profile and a second profile in response to a first input received by the computer device;
automatically retrieving, by an association heuristic of the appointment scheduler and management application, a plurality of availability instances of the second profile;
generating an interface presenting the availability instances; and
receiving a second input indicating a selection of one of the availability instances.

2. The computing device of claim 1, wherein the associating in response to a first input comprises selecting the second profile based on at least one characteristic identified by the first profile.

3. The computing device of claim 2, wherein the first input is a synchronization command and the at least one characteristic is a skill level, the synchronization command triggering the integrated appointment scheduler and management application to utilize the skill level identified by the first profile to associate the second profile with the first profile.

4. The computing device of claim 1, wherein the association heuristic retrieves the plurality of availability instances by:
retrieving open time instances within calendar information of the first and second profiles in accordance with a time range; and
automatically synchronizing the open time instances between the first and second profiles to generate the plurality of availability instances.

5. The computing device of claim 1, wherein the operations further comprise automatically synchronizing, based on the selection, calendar information of the second profile that is related to the one of the availability instances, and sending a request for approval to the second profile.

6. The computing device of claim 1, wherein the operations further comprises:
associating a third profile with the first profile and the second profile in response to the first input; and
automatically retrieving, by the association heuristic, a plurality of mutual availability instances for the second and third profiles.

7. The computing device of claim 6, wherein the association heuristic retrieves the plurality of availability instances by:
retrieving open time instances within calendar information of the first, second, and third profiles in accordance with a time range; and
automatically synchronizing the open time instances between the first, second, and third profiles to generate the plurality of availability instances.

8. The computing device of claim 6, wherein the associating the third input with the first profile and the second profile is based on at least one characteristic identified by the first profile.

9. The computing device of claim 6, wherein the first input is a synchronization command and the at least one characteristic is a location, the synchronization command triggering the integrated appointment scheduler and management application to utilize the location identified by the first profile to associate the second and third profiles with the first profile according a preferred location range of the first profile.

10. The computing device of claim 6, wherein the first profile is a member profile, the second profile is a provider profile, and the third profile is a facility profile.

11. A method, comprising:
associating a first profile and a second profile in response to a first input received by a computer having a processor and memory that stores an appointment scheduler and management application;
automatically retrieving, by an association heuristic of the appointment scheduler and management application, a plurality of availability instances of the second profile;
generating, by the computer, an interface presenting the availability instances; and
receiving a second input indicating a selection of one of the availability instances.

12. The method of claim 11, wherein the associating in response to a first input comprises selecting the second profile based on at least one characteristic identified by the first profile.

13. The method of claim 12, wherein the first input is a synchronization command and the at least one characteristic is a skill level, the synchronization command triggering the integrated appointment scheduler and management application to utilize the skill level identified by the first profile to associate the second profile with the first profile.

14. The method of claim 11, wherein the association heuristic retrieves the plurality of availability instances by:
retrieving open time instances within calendar information of the first and second profiles in accordance with a time range; and
automatically synchronizing the open time instances between the first and second profiles to generate the plurality of availability instances.

15. The method of claim 11, wherein the operations further comprise automatically synchronizing, based on the selection, calendar information of the second profile that is related to the one of the availability instances, and sending a request for approval to the second profile.

16. The method of claim 11, wherein the operations further comprises:
associating a third profile with the first profile and the second profile in response to the first input; and
automatically retrieving, by the association heuristic, a plurality of mutual availability instances for the second and third profiles.

17. The method of claim 16, wherein the association heuristic retrieves the plurality of availability instances by:
retrieving open time instances within calendar information of the first, second, and third profiles in accordance with a time range; and
automatically synchronizing the open time instances between the first, second, and third profiles to generate the plurality of availability instances.

18. The method of claim 16, wherein the associating the third input with the first profile and the second profile is based on at least one characteristic identified by the first profile.

19. The method of claim 16, wherein the first input is a synchronization command and the at least one characteristic is a location, the synchronization command triggering the integrated appointment scheduler and management application to utilize the location identified by the first profile to associate the second and third profiles with the first profile according a preferred location range of the first profile.

20. The method of claim 16, wherein the first profile is a member profile, the second profile is a provider profile, and the third profile is a facility profile.
